(19) United States
(12) Patent Application Publication
(10) Pub. No.: US 2026/0113066 A1
(43) Pub. Date: Apr. 23, 2026

(54) INTEROPERABLE PUSH-TO-TALK DEVICE FOR MICROPHONE-EQUIPPED HEADSETS

(71) Applicant: Joshua Bronson, Southern Pines, NC (US)

(72) Inventor: Joshua Bronson, Southern Pines, NC (US)

(21) Appl. No.: 19/364,158

(22) Filed: Oct. 21, 2025

Related U.S. Application Data
(60) Provisional application No. 63/710,335, filed on Oct. 22, 2024.

(51) Int. Cl. H04B 1/3827; G06F 3/16; H04R 1/08; H04R 1/10; H04R 29/00; H04W 4/10

(52) U.S. Cl. CPC H04B 1/3833; G06F 3/162; G06F 3/165; H04R 1/08; H04R 1/1008; H04R 29/001; H04R 29/004; H04R 2201/109; H04R 2420/09; H04W 4/10

(57) ABSTRACT

A push-to-talk device (PTT) and corresponding methods of operation are disclosed. The PTT device is configured to interoperate with microphone-equipped headsets having different wiring conventions and microphone systems. The PTT device includes a housing, a jack configured to receive a plug of the headset, a plug configured to connect the PTT device to a communication radio, and signal processing circuitry disposed within the housing. The signal processing circuitry is configured to detect a wiring convention of the headset and to route audio signals between the headset and the communication radio in accordance with the detected wiring convention. The signal processing circuitry is also configured to detect a type of microphone system of the headset.

### CROSS-REFERENCE TO RELATED APPLICATION(S)

This application claims the benefit of U.S. Provisional Application Ser. No. 63/710,335, filed on Oct. 22, 2024, the entirety of which is incorporated herein by reference.

### TECHNICAL FIELD

This disclosure relates to implementations of a push-to-talk (PTT) device configured to interoperate with microphone-equipped headsets having different wiring conventions and microphone systems, together with corresponding methods of operation.

### BACKGROUND

Push-to-talk (PTT) devices are commonly used to enable two-way communication between a headset and a portable communication radio. Conventional PTT devices typically provide a hardwired interface between a communication radio and a specific headset model. However, different headsets may employ different wiring conventions or microphone systems, such as dynamic or electret microphones, which require distinct electrical configurations for proper operation.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed are implementations of a push-to-talk device configured to interoperate with microphone-equipped headsets having different wiring conventions and microphone systems, together with corresponding methods of operation.

In one example implementation, a push-to-talk device configured to interconnect a headset and a communication radio is provided. The push-to-talk device comprises a housing, a jack configured to receive a plug of the headset, a plug configured to connect the push-to-talk device to the communication radio, and signal processing circuitry disposed within the housing. The signal processing circuitry is configured to detect a wiring convention of the headset and to detect a type of microphone system of the headset.

In another example implementation, the push-to-talk device comprises a housing, a jack configured to receive a plug of the headset, a plug configured to connect the push-to-talk device to the communication radio, an onboard power source, and an integrated charging circuit. The integrated charging circuit is electrically coupled to the onboard power source and configured to draw phantom power through a positive lead of a microphone system of the headset to recharge the onboard power source.

In yet another example implementation, a method of operating a push-to-talk device configured to interconnect a headset and a communication radio is provided. The method comprises: receiving a plug of the headset in a jack of the push-to-talk device; assessing, using a comparator of the push-to-talk device, a test line of the headset to determine whether the test line is connected to ground; and routing audio lines between the headset and the communication radio based on whether the test line is connected to ground.

Any aspect of any implementation, in combination with any one or more aspects of any other implementation(s).

Any one or more of the features disclosed herein.

Any one or more of the features as substantially disclosed herein.

Any one or more of the features as substantially disclosed herein, in combination with any one or more other features as substantially disclosed herein.

Any one of the aspects, features, or implementations, in combination with any one or more other aspects, features, or implementations.

Use of any one or more of the aspects or features disclosed herein.

It should be appreciated that any feature described herein can be claimed in combination with any other feature(s) described herein, regardless of whether the features originate from the same described implementation.

The details of one or more aspects of the disclosure are set forth in the accompanying drawings and the description below. Other features, objects, and advantages of the techniques described in this disclosure will be apparent from the description and drawings, and from the claims.

Numerous additional features and advantages of the present disclosure will become apparent to those skilled in the art upon consideration of the implementation descriptions provided below.

Additional features and advantages are described herein and will be apparent from the following description and figures.

### BRIEF DESCRIPTION OF THE DRAWINGS

FIG. 1 is a perspective view of a push-to-talk (PTT) device according to the principles of the present disclosure.

FIG. 2 is a view of a communication system that includes the PTT device shown in FIG. 1, a communication radio, and a headset.

FIG. 3 is a block diagram of a signal processing circuit according to the principles of the present disclosure.

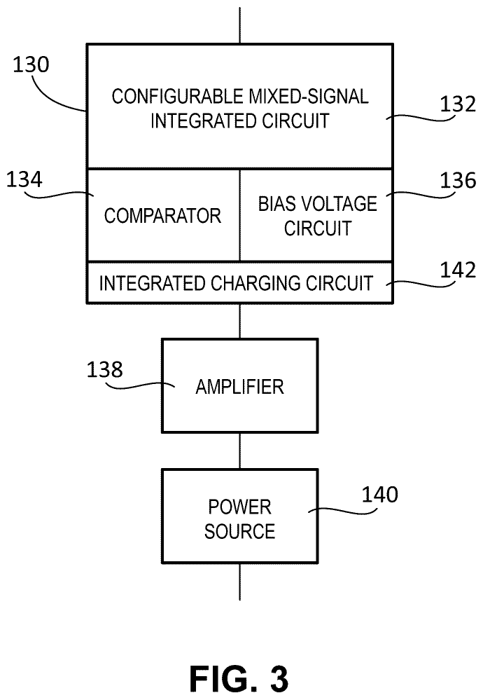

FIG. 4 is a flowchart illustrating a method implemented by the PTT device shown in FIG. 1 for detecting the wiring convention of a connected headset.

FIG. 5 is a flowchart illustrating a method implemented by the PTT device shown in FIG. 1 for detecting the microphone system of the connected headset.

Like reference numerals refer to corresponding parts throughout the several views of the drawings.

### DETAILED DESCRIPTION

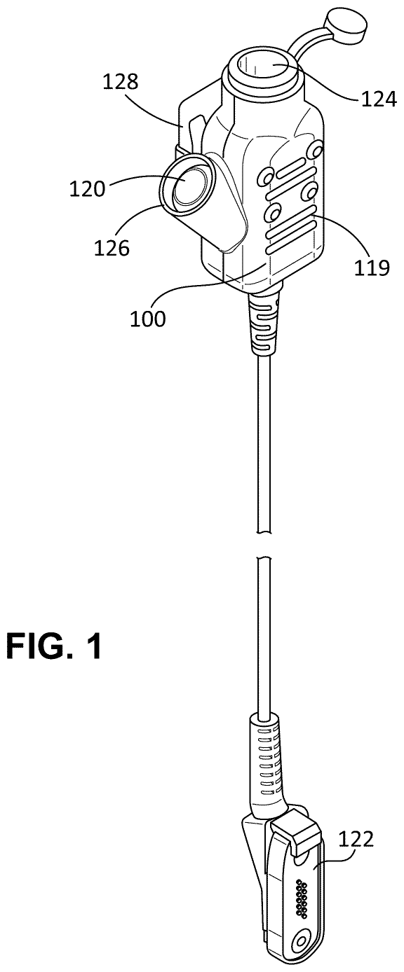

FIG. 1 illustrates a push-to-talk (PTT) device 100 according to the principles of the present disclosure. The PTT device 100 is configured to interoperate with microphone-equipped headsets 110 having different wiring conventions and microphone systems. In particular, the PTT device 100 is configured to detect the wiring convention and the microphone system of a connected headset 110 and reconfigure itself so that incoming audio is routed through the earcups 112 and sound detected by the boom microphone 114 is routed to a connected communication radio 116 for transmission.

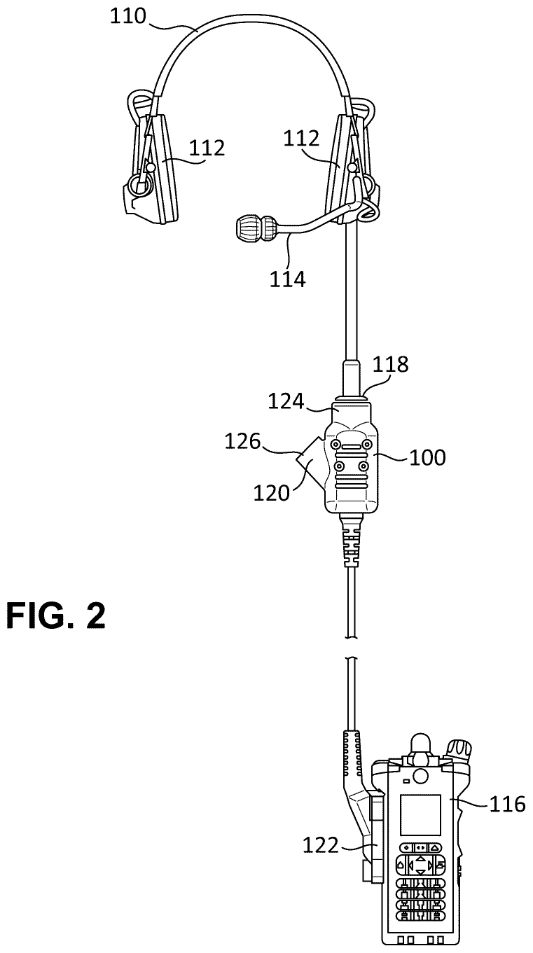

As shown in FIG. 2, the PTT device 100 can be used as part of a communication system that includes the PTT device 100, the headset 110, and the communication radio 116. The communication radio 116 is a handheld transceiver that includes a jack for connecting the PTT device 100 to the communication radio 116. The headset 110 comprises two earcups 112, a boom microphone 114, and a downlead cable with a plug 118 (e.g., a U-174 plug). Each earcup 112 includes a speaker that provides audio signals to the wearer. As previously described, the PTT device 100 is configured for use in conjunction with a variety of headsets having different wiring conventions and microphone systems. Suitable headsets include, but are not limited to, 3M™ PELTOR™ COMTAC™ headsets and OPS-CORE AMP communication headsets.

The PTT device 100 connects the communication radio 116 with the headset 110. The PTT device 100 comprises a switch 120, a downlead cable with a plug 122 configured to interface with the communication radio 116, and a jack 124 for receiving the plug 118 of the headset 110. The PTT device 100 also includes signal processing circuitry 130 configured to detect the wiring convention and the microphone system of the connected headset 110, and to reconfigure itself so that incoming audio from the communication radio 116 is routed through the earcups 112 and sound detected by the boom microphone 114 is routed to the communication radio 116 for transmission.

The switch 120 of the PTT device 100 may be a momentary switch that provides a tactile “click” or any other suitable switching mechanism configured to selectively switch the communication radio 116 between a transmit mode and a receive mode. For example, when the switch 120 of the PTT device 100 is actuated, the communication radio 116 may transmit communications, and when the switch 120 is not actuated, the communication radio 116 may receive communications. A shroud 126 may be positioned around the button of the switch 120 to prevent accidental activation.

The downlead cable and plug 122 are adapted for coupling the PTT device 100 to the communication radio 116. The communication radio 116 includes a jack that provides a connection point for the plug 122, allowing secure attachment and signal transmission between the devices.

The jack 124 of the PTT device 100 is a U-94 type jack, providing a connection point for the plug 118 of the headset 110 to allow secure attachment and signal transmission between the devices. Although a U-94 type jack 124 is used, any multi-contact audio connector (e.g., such as a jack) suitable for establishing signal transmission between the PTT device 100 and the headset 110 may be used.

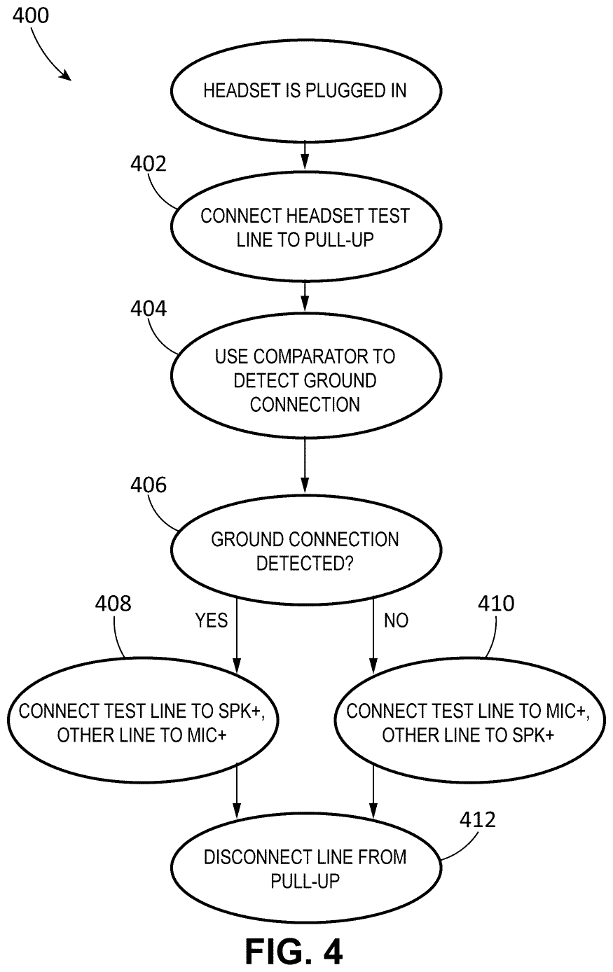

FIG. 4 illustrates a method 400 implemented by the signal processing circuitry 130 of the PTT device 100 for detecting the wiring convention of a connected headset 110. Initially, a comparator 134 within the PTT device 100 assesses a test line of the connected headset 110 (Step 402) to determine whether it is connected to ground (Step 404). Using voltage signals, the comparator 134 detects the orientation of the speaker and microphone leads in the plug 118 of the connected headset 110. The orientation of the leads correlates with the wiring convention, such as PELTOR™ or NATO wiring conventions, of the connected headset 110. If a ground connection is detected (Step 406), the signal processing circuitry 130 routes the test line to the earcups 112 of the headset 110 and the other line to the boom microphone 114 (Step 408). Alternatively, if a ground connection is not detected (Step 406), the signal processing circuitry 130 routes the test line to the boom microphone 114 of the headset 110 and the other line to the earcups 112 (Step 410). Once routing is complete, the comparator 134 of the signal processing circuitry 130 disconnects from the test line of the connected headset 110 (Step 412).

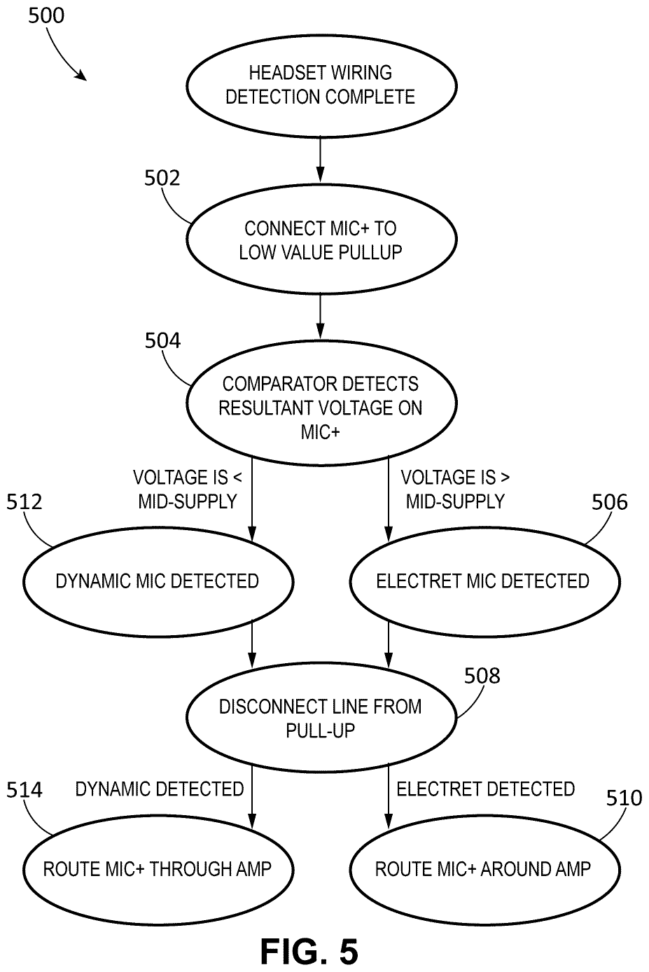

FIG. 5 illustrates a method 500 implemented by the signal processing circuitry 130 of the PTT device 100 for detecting the microphone system of the connected headset 110. Initially, a line connected to the microphone system is routed to the comparator 134 (Step 502) of the signal processing circuitry 130 to identify the type of microphone system present, such as a dynamic or electret microphone system. The comparator 134 uses voltage levels to detect whether the connected microphone system requires a bias voltage (Step 504). If the detected voltage is greater than the mid-supply, the connected microphone system is an electret microphone system (Step 506), and the line is disconnected from the comparator 134 (Step 508) and routed to bypass an amplifier 138 of the PTT device 100 (Step 510). Alternatively, if the detected voltage is less than the mid-supply, the connected microphone system is a dynamic microphone system (Step 512), and the line is disconnected from the comparator 134 (Step 508) and routed through the amplifier 138 (Step 514).

The example implementation of the signal processing circuitry 130 of the PTT device 100 performs the steps necessary to detect the wiring convention before proceeding to detect the microphone system. In other implementations, the steps necessary to detect the wiring convention and the microphone system may be performed concurrently or substantially concurrently.

The signal processing circuitry 130 of the PTT device 100 executes steps, including the steps described herein as facilitated by the PTT device 100. The signal processing circuitry 130 is housed within the PTT device 100 and includes at least one configurable mixed-signal integrated circuit (IC) 132, such as, but not limited to, a GreenPAK™ mixed-signal IC from Renesas Electronics. The signal processing circuitry 130 also includes a comparator 134, a bias voltage circuit 136 for identifying the microphone system type, and an amplifier 138 to boost the signal from dynamic microphone systems.

The configurable mixed-signal IC 132 includes configurable digital logic blocks and analog components, such as the comparator 134 and the bias voltage circuit 136. The digital logic blocks are configured using software tools, such as GreenPAK Designer, to set up interconnections and parameters necessary to execute functions, including the steps described herein as facilitated by the PTT device 100. The configurable mixed-signal IC 132 is designed to handle both analog and digital signals. The mixed-signal IC 132 may include non-volatile memory (NVM) for storing configuration settings, volatile memory such as registers and flip-flops, and look-up-tables (LUTs), or a suitable combination thereof. LUTs are used by the PTT device 100 to implement logic functions and to perform digital logic operations based on input conditions, such as detecting the connection of a headset 110 to the PTT device 100.

In alternate implementations, the comparator 134 and/or amplifier 138 may be discrete components rather than integrated within the configurable mixed-signal IC 132.

The signal processing circuitry 130 of the PTT device 100 is powered by a rechargeable lithium-ion battery 140 housed within the PTT device 100. Although the example power source 140 is a rechargeable lithium-ion cell, other suitable rechargeable power sources could be used. The onboard power source 140 may be recharged using an integrated charging circuit 142 that draws bias (phantom) power supplied through the positive lead of the microphone system. In some implementations, the integrated charging circuit 142 may be configured to draw 2.2 mA or less to prevent audio distortion.

In some implementations, the signal processing circuitry 130 of the PTT device 100 is configured to check for the presence of a power rail when a communication radio 116 is connected to the PTT device 100. Once the PTT device 100 is connected to the communication radio 116 and the communication radio 116 is turned on, the signal processing circuitry 130 may perform the following steps to detect the presence of a power rail. First, the comparator 134 of the PTT device 100 assesses a test line from the connected communication radio 116 to determine whether a power rail is present. If the comparator 134 detects a power rail, the signal processing circuitry 130 of the PTT device 100 uses the power rail, bypassing the internal power source 140. Alternatively, if the comparator 134 does not detect a power rail, the internal power source 140 powers the signal processing circuitry 130 of the PTT device 100.

In some implementations, the signal processing circuitry 130 of the PTT device 100 is configured to perform filtering to mitigate radio-frequency (RF) noise associated with Time Division Multiple Access (TDMA) transmissions and other burst-mode communication protocols on signals received from the headset 110 and/or the communication radio 116. This facilitates RF noise management by removing interference (i.e., audio artifacts) from audio signals received (e.g., sounds emitted by the speaker(s) of the earcup(s) 112) and audio signals transmitted (e.g., speech spoken into the boom microphone 114) by the user. In some implementations, the signal processing circuitry 130 is configured to perform RF noise filtering on the positive lead of the microphone system, the filtering being synchronized with TDMA operation and occurring when power is drawn from a power rail of a connected communication radio 116.

Unless otherwise indicated, it should be understood that suitable wiring, traces, or combinations thereof connect the electrical components of the PTT device 100 disclosed herein.

In some implementations, the PTT device 100 includes a retainer clip 128 secured to the back of the housing 119 with threaded fasteners (see, e.g., FIG. 1). The retainer clip 128 allows the PTT device 100 to be attached to the user's clothing or nylon gear.

The foregoing description of the invention is intended to be illustrative; it is not intended to be exhaustive or to limit the claims to the precise forms disclosed. Those skilled in the relevant art can appreciate that many modifications and variations are possible in light of the foregoing description and associated drawings.

Reference throughout this specification to an “embodiment,” “implementation,” or words of similar import indicates that a particular described feature, structure, or characteristic is included in at least one embodiment of the present disclosure. Thus, the phrase “in some implementations,” or a phrase of similar import, as used throughout this specification, does not necessarily refer to the same embodiment.

The described features, structures, or characteristics may be combined in any suitable manner in one or more embodiments. In the above description, numerous specific details are provided for a thorough understanding of embodiments of the present disclosure. One skilled in the relevant art will recognize, however, that embodiments of the present disclosure can be practiced without one or more of the specific details, or with other methods, components, materials, etc. In other instances, well-known structures, materials, or operations may not be shown or described in detail.

1. A push-to-talk device configured to connect a communication radio with a headset, the push-to-talk device comprising:
a housing;
a jack configured to receive a plug of the headset;
a plug configured to connect the push-to-talk device to the communication radio; and
signal processing circuitry disposed within the housing and configured to:
detect a wiring convention of the headset; and
detect a type of microphone system of the headset.

2. The push-to-talk device of claim 1, wherein the signal processing circuitry is configured to detect the wiring convention of the headset by assessing at least one test line of the headset to determine whether the test line is connected to ground, and to route audio signals between the headset and the communication radio in accordance with the detected wiring convention.

3. The push-to-talk device of claim 2, wherein the signal processing circuitry is configured to route the test line to either a microphone or a speaker of the headset in accordance with the detected wiring convention.

4. The push-to-talk device of claim 2, wherein the signal processing circuitry is configured to detect the type of microphone system of the headset by assessing a voltage level on a line connected to the microphone of the headset to determine whether the microphone system requires a bias voltage, and to route the line through an amplifier or to bypass the amplifier in response to the detected microphone system.

5. The push-to-talk device of claim 4, further comprising an onboard power source and an integrated charging circuit electrically coupled to the onboard power source, the integrated charging circuit configured to draw phantom power through a positive lead of the microphone system to recharge the onboard power source.

6. The push-to-talk device of claim 5, wherein the signal processing circuitry is configured to assess a test line from the communication radio to determine whether a power rail is present, and to selectively power the signal processing circuitry using the power rail when the power rail is detected or the onboard power source when the power rail is not detected.

7. The push-to-talk device of claim 6, wherein the signal processing circuitry includes a comparator configured to assess the test line from the communication radio to detect the presence of the power rail.

8. The push-to-talk device of claim 1, further comprising a switch supported by the housing and operable to selectively place the communication radio in a transmit mode.

9. The push-to-talk device of claim 1, wherein the signal processing circuitry is configured to perform filtering to mitigate radio-frequency noise associated with burst mode communication protocols on signals received from the headset and the communication radio.

10. A method of operating a push-to-talk device configured to interconnect a headset and a communication radio, the method comprising:
receiving a plug of the headset in a jack of the push-to-talk device;
assessing, using a comparator of the push-to-talk device, a test line of the headset to determine whether the test line is connected to ground; and
routing audio lines between the headset and the communication radio based on whether the test line is connected to ground.

11. The method of claim 10, further comprising routing the test line to either a microphone or a speaker of the headset based on whether the test line is connected to ground.

12. The method of claim 10, further comprising: assessing, using the comparator, a voltage level on a microphone line of the headset to identify a type of microphone system connected to the push-to-talk device; determining, based on the voltage level, whether the microphone system is an electret microphone system or a dynamic microphone system; and routing the microphone line through an amplifier or bypassing the amplifier based on the determined microphone system.

13. The method of claim 12, further comprising: receiving phantom power through a positive lead of the microphone system connected to the push-to-talk device; and recharging, using an integrated charging circuit of the push-to-talk device, the onboard power source with the received phantom power.

14. A push-to-talk device configured to connect a communication radio with a headset, the push-to-talk device comprising:
a housing;
a jack configured to receive a plug of the headset;
a plug configured to connect the push-to-talk device to the communication radio;
an onboard power source; and
an integrated charging circuit electrically coupled to the onboard power source and configured to draw phantom power through a positive lead of a microphone system of the headset to recharge the onboard power source.

15. The push-to-talk device of claim 14, further comprising signal processing circuitry disposed within the housing and configured to: detect a wiring convention of the headset; and detect a type of microphone system of the headset.

16. The push-to-talk device of claim 15, wherein the signal processing circuitry is configured to detect the wiring convention of the headset by assessing at least one test line of the headset to determine whether the test line is connected to ground, and to route audio signals between the headset and the communication radio in accordance with the detected wiring convention.

17. The push-to-talk device of claim 16, wherein the signal processing circuitry is configured to route the test line to either a microphone or a speaker of the headset in accordance with the detected wiring convention.

18. The push-to-talk device of claim 16, wherein the signal processing circuitry is configured to detect the microphone system of the headset by assessing a voltage level on a line connected to a microphone of the headset to determine whether the microphone system requires a bias voltage, and to route the line through an amplifier or to bypass the amplifier in response to the detected microphone system.

19. The push-to-talk device of claim 15, wherein the signal processing circuitry is configured to assess a test line from the communication radio to determine whether a power rail is present, and to selectively power the signal processing circuitry using the power rail when the power rail is detected or the onboard power source when the power rail is not detected.

20. The push-to-talk device of claim 14, further comprising a switch supported by the housing and operable to selectively place the communication radio in a transmit mode.
